(19) United States
(12) Patent Application Publication
(10) Pub. No.: US 2015/0098050 A1
(43) Pub. Date: Apr. 9, 2015

(54) LIQUID CRYSTAL DISPLAY

(71) Applicant: Samsung Display Co., Ltd., Yongin-City (KR)

(72) Inventors: Hyeon Gu CHO, Yongin-si (KR); Duck Jong SUH, Seoul (KR); Hyun Ku AHN, Hwaseong-si (KR); Jae Jin LYU, Yongin-si (KR)

(21) Appl. No.: 14/310,918

(22) Filed: Jun. 20, 2014

(30) Foreign Application Priority Data
Oct. 7, 2013 (KR) 10-2013-0119355

(51) Int. Cl. G02F 1/1337

(52) U.S. Cl. CPC G02F 1/1337; G02F 2001/133773; G02F 2001/133397
USPC 349/123

(57) ABSTRACT

A liquid crystal display includes: a first substrate and a second substrate facing each other; an alignment layer positioned on at least one of the first substrate and the second substrate; and a liquid crystal layer positioned between the first substrate and the second substrate, wherein the alignment layer includes a main chain and at least one side chain connected to the main chain, the at least one side chain includes at least one kind of vertical alignment side chain and at least two kinds of reaction monomer side chains, the reaction monomer side chains include a main reaction monomer and a sub-reaction monomer, and a length of the main reaction monomer is longer than the length of the sub-reaction monomer. The liquid crystal display provides an excellent pretilt characteristic and improved modulus of the formed polymer, thereby minimizing the afterimage.

### CROSS-REFERENCE TO RELATED APPLICATION

This application claims priority to and the benefit of Korean Patent Application No. 10-2013-0119355 filed in the Korean Intellectual Property Office on Oct. 7, 2013, the entire contents of which are incorporated herein by reference.

### BACKGROUND

(a) Technical Field

The present invention relates to a liquid crystal display.

(b) Description of the Related Art

A liquid crystal display is a widely used type of flat panel display. Liquid crystal displays include two display panel sheets in which field generating electrodes, such as pixel electrodes and common electrodes, are formed, and a liquid crystal layer interposed between the display panels. In the liquid crystal display, a voltage is applied to the field generating electrodes to generate an electric field in the liquid crystal layer, which determines the direction of liquid crystal molecules of the liquid crystal layer. An image is displayed by controlling the polarization of incident light via the direction of the liquid crystal molecules.

An alignment layer is formed on the inner surfaces of the two display panels to align liquid crystal molecules of the liquid crystal layer. If no voltage is applied to the field generating electrodes, the liquid crystal molecules of the liquid crystal layer are aligned in a predetermined direction by way of the alignment layer, while with the application of a voltage to the field generating electrodes, the liquid crystal molecules of the liquid crystal layer are rotated in the direction of the electric field.

For the liquid crystal alignment, a polymer alignment layer is formed, and a rubbing process in which a rotation roller covered with a rubbing fabric, such as nylon and rayon, is rubbed on the alignment layer while rolling with rotation. However, the rubbing causes mechanical scratches to the surface of the liquid crystal alignment agent, and may cause a high static electricity, such that the thin film transistor may be damaged. Also, a defect due to a fine fiber generated from the rubbing fabric may be generated, such that improvement of a production yield may be interrupted.

To resolve these problems of the rubbing process, a liquid crystal alignment method that uses light, such as UV light (hereinafter “photo-alignment”), has been developed. The photo-alignment occurs via a mechanism in which a photosensitive group coupled to a photoreactive polymer is irradiated with linearly polarized UV light, and the main chain of the polymer is arranged in a predetermined direction in this process, and resultantly, the liquid crystal is aligned, thereby forming a photo-polymerizable liquid crystal alignment layer.

However, the liquid crystal display formed by using the photo-polymerizable liquid crystal alignment layer has an afterimage defect.

The above information disclosed in this Background section is only for enhancement of understanding of the background and therefore it may contain information that does not form the prior art that is already known to a person of ordinary skill in the art.

### SUMMARY

An alignment layer obtaining an excellent pretilt characteristic and simultaneously increasing a modulus of a polymer by connecting two or more reaction monomer side chains having different lengths to a main chain thereby minimizing an afterimage, and a liquid crystal display, are provided.

A liquid crystal display includes: a first substrate and a second substrate facing each other; an alignment layer positioned on at least one of the first substrate and the second substrate; and a liquid crystal layer positioned between the first substrate and the second substrate, wherein the alignment layer includes a main chain and at least one side chain connected to the main chain, the at least one side chain includes at least one kind of vertical alignment side chain and at least two kinds of reaction monomer side chains, the reaction monomer side chains include a main reaction monomer and a sub-reaction monomer, and a length of the main reaction monomer is longer than the length of the sub-reaction monomer.

The main chain may include at least one selected from a group including polyimide, polyamic acid, polyamide, polyamic-imide, polyester, polyethylene, polyurethane, and polystyrene.

The main chain may be a polyimide.

At least one side chain may be connected to a diamine group of the polyimide main chain.

The vertical alignment side chain may include at least one mesogen unit.

The vertical alignment side chain may include at least one functional group selected from a group including a cholesteric group, a biphenyl group, a cyclohexyl benzene group, and a naphthyl group.

The vertical alignment side chain may include an alkyl group.

The vertical alignment side chain may include two or more vertical alignment side chains having different lengths.

The side chain with the shorter length among the vertical alignment side chains may have s chain length with a carbon number of 4 to 6.

The side chain with the longer length among the vertical alignment side chains may have a chain length with a carbon number of 9 to 11.

The vertical alignment side chains may have the same length, and the chain length has a carbon number of 4 to 6.

The vertical alignment side chains may have the same length, and the chain length has a carbon number of 9 to 11.

The main reaction monomer and the sub-reaction monomer may include at least one acryl group or methacryl group at an end.

The main reaction monomer may include a benzene ring or a cyclohexyl group.

The benzene ring or the cyclohexyl group of the main reaction monomer may be connected to the main chain by a chain with a carbon number of 8 to 20.

The benzene ring or the cyclohexyl group of the main reaction monomer may be connected to the main chain by a chain with a carbon number of 10 to 18.

The sub-reaction monomer may not include the benzene ring or the cyclohexyl group.

The sub-reaction monomer may have a chain length with a carbon number of 4 to 10.

A chain length difference between the main reaction monomer and the sub-reaction monomer may have a carbon number of 5 to 10.

The chain length difference between the main reaction monomer and the sub-reaction monomer may have carbon number of 5 to 6.

In a liquid crystal display, two or more reactive monomer side chains having different lengths are connected to the main chain of the alignment layer such that the reactivity of the photo-polymerization reaction is improved, the modulus of the formed polymer is increased, and the afterimage characteristic is improved.

### BRIEF DESCRIPTION OF THE DRAWINGS

FIG. 1 is a cross-sectional view of a liquid crystal display according to an example embodiment.

FIG. 2 is a schematic view of a coupling shape of an alignment layer according to an example embodiment.

FIG. 3 is a schematic view of a coupling shape of an alignment layer according to another example embodiment.

FIG. 4 is a schematic view of a coupling shape of an alignment layer according to a comparative example.

### DETAILED DESCRIPTION OF THE EMBODIMENTS

The present disclosure will be described more fully hereinafter with reference to the accompanying drawings, in which example embodiments are shown. As those skilled in the art would realize, the described embodiments may be modified in various different ways, all without departing from the spirit or scope of the present disclosure.

In the drawings, the thickness of layers, films, panels, regions, etc., are exaggerated for clarity. Like reference numerals designate like elements throughout. It will be understood that when an element such as a layer, film, region, or substrate is referred to as being “on” another element, it can be directly on the other element, or intervening elements may also be present. In contrast, when an element is referred to as being “directly on” another element, there are no intervening elements present.

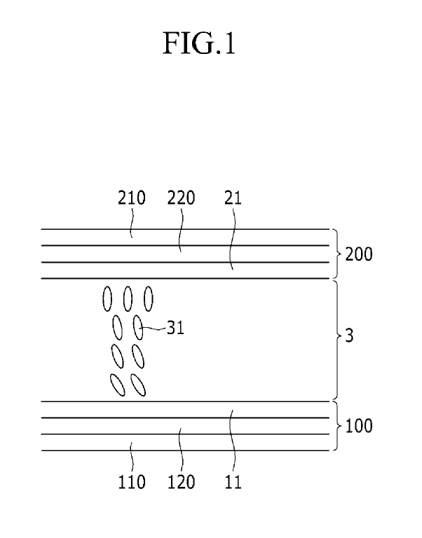

Firstly, a liquid crystal display according to an example embodiment will be described with reference to FIG. 1. FIG. 1 is a cross-sectional view of a liquid crystal display according to an example embodiment. Referring to FIG. 1, the liquid crystal display has a vertical alignment (VA) mode. The liquid crystal display includes a first display panel 100 and a second display panel 200 facing each other, and a liquid crystal layer 3 disposed between the first display panel 100 and the second display panel 200.

The first display panel 100 includes a first substrate 110. The first substrate 110 may be an insulation substrate made of a material such as glass or plastic. A thin film layer 120 is positioned on the first substrate 110. The first thin film 120 may include (not shown) at least one of a wiring layer, an electrode layer, an insulating layer, and a semiconductor layer, and the first thin film 120 may include at least one of a light blocking layer and a color filter, for the display panel as understood by a person of ordinary skill in the art.

The first thin film 120 may include (not shown) a plurality of signal lines, a switching element such as a thin film transistor connected thereto, and a plurality of pixel electrodes connected to the switching element, for the display panel as understood by a person of ordinary skill in the art. The pixel electrode is physically and electrically connected to the switching element through a contact hole, and is made of a transparent conductive material.

A first alignment layer 11 is positioned on the first thin film layer 120.

The second display panel 200 includes a second substrate 210. The second substrate 210 may be an insulation substrate made of a material such as glass or plastic. A second thin film 220 is positioned on the second substrate 210. The second thin film 220 may include (not shown) at least one of a wiring layer, an electrode layer, an insulating layer, and a semiconductor layer, and the second thin film 220 may include at least one of a light blocking layer and a color filter, for the display panel as understood by a person of ordinary skill in the art. The second thin film 220 may include an opposed electrode facing the pixel electrode of the first thin film 120. A second alignment layer 21 is positioned on the second thin film 220.

A liquid crystal material 31 of the liquid crystal layer 3 has dielectric anisotropy. The liquid crystal material 31 may be aligned to be approximately perpendicular to surfaces of the two substrates 110 and 210, however it may be inclined to have a predetermined pretilt angle with respect to a line perpendicular to the surfaces of the substrate 110 and 210 at a position where the liquid crystal material 31 contacts the alignment layers 11 and 21.

The liquid crystal display includes a plurality of pixels as a unit displaying images. To realize a wide viewing angle, in the liquid crystal display having a vertical alignment (VA) mode, one pixel may include a plurality of domains in which alignment directions of the liquid crystal material 31 are different from each.

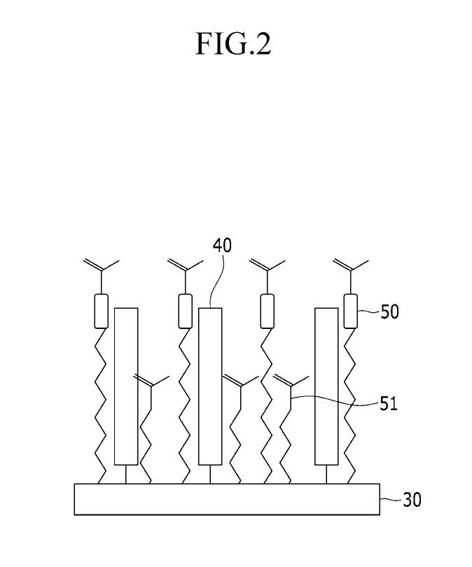

The first alignment layer 11 applied to the liquid crystal display according to an example embodiment will be described with reference to FIGS. 2 to 4. The description for the first alignment layer 11 may be equally applied to the second alignment layer 21.

Referring to FIG. 2, the alignment layer according to an example embodiment includes a main chain 30 and at least one side chain connected to the main chain, the at least one side chain includes at least one kind vertical alignment side chain 40 and reaction monomer side chains, and the reaction monomer side chains include at least two kinds of reaction monomer side chains: a main reaction monomer 50 and a sub-reaction monomer 51.

The reaction monomer side chain is configured of the main reaction monomer 50 and the sub-reaction monomer 51, and a length of the main reaction monomer 50 is longer than the length of the sub-reaction monomer 51. That is, as set forth herein, “a main reaction monomer” means the monomer having the longer length among the reaction monomer side chains connected to the main chain, and “a sub-reaction monomer” means the reaction monomer having the shorter length among the reaction monomer side chains connected to the main chain.

In a display panel having an alignment layer including the reaction monomer connected to the main chain of the Comparative Example, an afterimage is generated due to the low reactivity of the reaction monomer. The cause of the afterimage is that a modulus of the polymer of the alignment layer surface generated by the photo-polymerization reaction between the reaction monomer functional groups is low. As used herein, “modulus of the polymer” means resistance of the polymer to stress, an more specifically, resistance to a change in pretilt direction when there is a change in voltage applied to the LC. The pretilt of the liquid crystal additionally formed by the electric field stress is not removed as a result of the low modulus such that the afterimage is generated. Accordingly, to solve the afterimage problem, the modulus of the polymer generated by the photo-polymerization reaction between the reaction monomer functional groups must be increased. To increase the modulus of the polymer, it is important to increase the reactivity of the reaction monomer functional group by increasing the molecular weight. However, it is not easy to increase the reactivity of the functional group through the reaction monomer connected to the conventional main chain.

When independently connecting the reaction monomer having a chain length with a carbon number of more than 11 to the main chain, the pretilt of the alignment layer is formed well, however an afterimage is present in the display. However, when independently connecting the reaction monomer having a chain length with a carbon number of less than 6, the pretilt of the alignment layer is not easily formed. As used herein, the “chain length” means a number of carbon-carbon combinations, i.e., the number of carbon-carbon bonds in the chain extending along the length direction of the polymer.

In the alignment layer according to an example embodiment, however, reaction monomers having two or more different lengths are connected to the main chain to increase the modulus of the polymer formed when performing the photo-polymerization. That is, the main reaction monomer 50 and the sub-reaction monomer 51 are each separately connected to the main chain. As a result, the polymerization reaction is generated between the main reaction monomers having the longer length, the polymerization reaction is generated between the sub-reaction monomers having the shorter length, and the polymerization reaction is generated between the main reaction monomer and the sub-reaction monomer such that the same effect as increasing the reactivity of the reaction monomer functional group may be obtained. Accordingly, the modulus of the polymer that is photo-polymerized is increased. By the increased modulus, the afterimage characteristic is improved when the alignment layer is applied to the liquid crystal display.

The main chain 30 may be, for example, a polyimide main chain, however it is not limited thereto. The main chain may, for example, include at least one of polyimide, polyamic acid, polyamide, polyamic-imide, polyester, polyethylene, polyurethane, and polystyrene. As the main chain further includes the ring structure such as, for example, the imide group, rigidity of the main chain may be reinforced, the electrical characteristic may be improved such that stains generated when driving the liquid crystal display for a long time may be reduced, and stability of the pretilt of the alignment layer may be reinforced,

At least one side chain may, for example, be connected to a diamine group of the main chain 30. The diamine may be a photo-reactive diamine, a vertical diamine, or a normal diamine. At least one diamine of the photo-reactive diamine, the vertical diamine, and the normal diamine may be used in the manufacturing of the photo-alignment layer. Also, for the manufacturing of the photo-alignment layer, more than one kind of reaction diamine may be used, more than one kind of vertical diamine may be used, and more than one kind of normal diamine may be used. By controlling a composition ratio of the photo-reactive diamine, the vertical diamine, and the normal diamine, a good vertical alignment characteristic and optimization of the alignment stability are possible.

Side chains connected to main chain 30 may include at least one kind of vertical alignment side chain 40 and more than one kind of reaction monomer side chain. The vertical alignment side chain performs a function of obtaining a vertical alignment force in the VA mode.

The vertical alignment side chain 40 may, for example, include at least one mesogen unit to obtain the vertical alignment force. The mesogen unit may, for example, be at least one selected from a group including a cholesteric group, a biphenyl group, a cyclohexyl benzene group, and a naphthyl group.

In an example embodiment, a distance between the mesogen unit and the main chain may be a chain length of one carbon number. Also, the mesogen unit may, for example, be benzene.

In an example embodiment, the vertical alignment side chain 40 may include an alkyl chain. When the vertical alignment side chain includes the alkyl chain, the vertical alignment force is further reinforced. The vertical alignment side chain may include the alkyl chain at an end section. However, the alkyl chain may be included at the middle section of the vertical alignment side chain, not the end section.

The vertical alignment side chain 40 may be formed of two or more vertical alignment side chains having the different lengths.

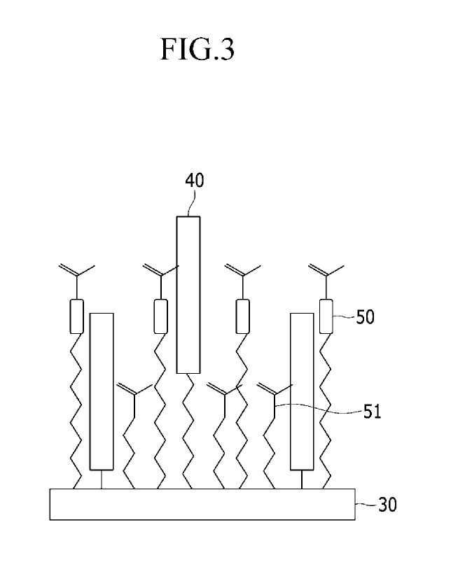

The side chain that has the shorter length among the vertical alignment side chains may have a chain (linker) length with a carbon number of 4 to 6. The side chain that has the longer length among the vertical alignment side chains may have a chain (linker) length with a carbon number of 9 to 11. A case in which the vertical alignment side chains having the different lengths are mixed is shown in FIG. 3. As shown in FIG. 3, when using the vertical alignment side chains having the different lengths, an interval between the reaction monomers is reduced and steric hindrance is minimized, thereby maximizing a reaction ratio.

The vertical alignment side chains may have the same chain length. In this case, the chain length may have a carbon number of 4 to 6. Or, the chain length may have a carbon number of 9 to 11. When the chain length has a carbon number of 9 to 11, the steric hindrance is minimized such that the reactivity is improved, the modulus of the polymer formed by the photo-polymerization is increased, and the afterimage is minimized.

In the liquid crystal alignment layer according to an example embodiment, the main reaction monomer 50 and the sub-reaction monomer 51 may include, for example, at least one acryl group or methacryl group at the end. The acryl group or the methacryl group forms the polymer by the photo-polymerization reaction when irradiating ultraviolet rays. The photo-polymerization reaction is respectively generated between main reaction monomers and main reaction monomers, sub-reaction monomers and sub-reaction monomers, and the main reaction monomers and sub-reaction monomers such that the reaction is further generated compared with a case when one reaction monomer is used. Accordingly, the modulus of the generated polymer is increased and the afterimage is smoothed by the increasing of the modulus.

The main reaction monomer 50 may include, for example, a benzene ring or a cyclohexyl group. The benzene ring or the cyclohexyl group contributes to the stability (rigidity) of the chain.

The benzene ring or the cyclohexyl group of the main reaction monomer 50 may be connected to the main chain by a chain length with a carbon number of 8 to 20.

Also, the benzene ring or the cyclohexyl group of the main reaction monomer 50 may be connected to the main chain by a chain length with a carbon number of 10 to 18. In an example embodiment, the chain length may have a carbon number of 15.

The sub-reaction monomer 51 may not include the benzene ring or the cyclohexyl group.

The sub-reaction monomer 51 may have a chain length with a carbon number of 4 to 10.

In an example embodiment, a chain length difference between the main reaction monomer 50 and the sub-reaction monomer 51 may have a carbon number of 5 to 10. More preferably, it may have a carbon number of 6.

In the liquid crystal display according to an example embodiment, the photo-polymerization reaction is generated between main reaction monomers and main reacton monomers, sub-reaction monomers and sub-reaction monomers, and main reaction monomers and sub-reaction monomers, such that the reactivity is increased and the modulus of the polymer is increased compared with the case in which only one reaction monomer is used, thereby improving the afterimage characteristic.

In a case in which only the reaction monomer having a chain length with a carbon number of more than 11 is used, the pretilt of the alignment layer is well formed, however the afterimage is bad. However, in a case in which a reaction monomer having a chain length with a carbon number of less than 6 is used, the pretilt of the alignment layer is not formed well.

In the present disclosure, the main reaction monomer and the sub-reaction monomer having the different lengths are mixed and used to form the alignment layer such that a desirable pretilt characteristic is obtained and simultaneously the afterimage is reduced.

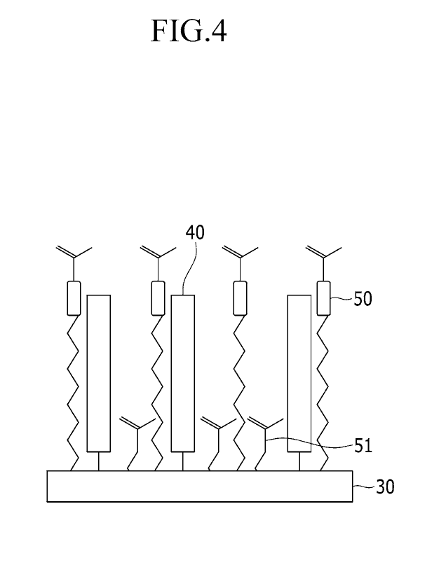

FIG. 4 is a view of an alignment layer of a liquid crystal display according to a comparative example. In FIG. 4, the chain length of the main reaction monomer 50 has a carbon number of 15, and the chain length of the sub-reaction monomer 51 has a carbon number of 3. In this case, the distance between the main reaction monomer 50 and the sub-reaction monomer 51 is far such that the polymerization reaction is not generated between the main reaction monomer 50 and the sub-reaction monomer 51. Accordingly, the modulus of the polymer generated by the photo-polymerization reaction is not largely increased.

In contrast, in the alignment layer of the liquid crystal display according to an example embodiment shown in FIG. 2 and FIG. 3, the chain length of the main reaction monomer 50 may have a carbon number of 15, and the chain length of the sub-reaction monomer 51 may have a carbon number of 6. In this case, the distance between the main reaction monomer 50 and the sub-reaction monomer 51 is sufficient to generate the photo-polymerization reaction such that the photo-polymerization reaction between the main reaction monomers and the sub-reaction monomers is generated when irradiating ultraviolet rays. This has a similar effect to the cross-linked bond, and the modulus of the polymer is increased. By the increased the modulus, the alignment layer according to an example embodiment may obtain an excellent pretilt characteristic and minimize the afterimage.

While this disclosure has been described in connection with what is presently considered to be practical example embodiments, it is to be understood that the invention is not limited to the disclosed embodiments, but, on the contrary, is intended to cover various modifications and equivalent arrangements included within the spirit and scope of the disclosure, including the appended claims.

<Description of Symbols>

| | |
|---|---|
| 3: | liquid crystal layer |
| 11: | first alignment layer |
| 21: | second alignment layer |
| 30: | main chain |
| 31: | liquid crystal material |
| 40: | vertical alignment side chain |
| 50: | main reaction monomer |
| 51: | sub-reaction monomer |
| 100: | first display panel |
| 110: | first substrate |
| 120, 220: | thin film |
| 200: | second display panel |
| 210: | second substrate |

What is claimed is:

1. A liquid crystal display comprising:
a first substrate and a second substrate facing each other;
an alignment layer positioned on at least one of the first substrate and the second substrate; and
a liquid crystal layer positioned between the first substrate and the second substrate,
wherein the alignment layer includes a main chain and at least one side chain connected to the main chain,
the at least one side chain includes at least one kind of vertical alignment side chain and at least two kinds of reaction monomer side chains,
the reaction monomer side chains include a main reaction monomer and a sub-reaction monomer, and
a length of the main reaction monomer is longer than the length of the sub-reaction monomer.

2. The liquid crystal display of claim 1, wherein
the main chain includes at least one selected from a group including polyimide, polyamic acid, polyamide, polyamic-imide, polyester, polyethylene, polyurethane, and polystyrene.

3. The liquid crystal display of claim 2, wherein
the main chain is a polyimide.

4. The liquid crystal display of claim 3, wherein
at least one side chain is connected to a diamine group of the polyimide main chain.

5. The liquid crystal display of claim 1, wherein
the vertical alignment side chain includes at least one mesogen unit.

6. The liquid crystal display of claim 1, wherein
the vertical alignment side chain includes at least one functional group selected from a group including a cholesteric group, a biphenyl group, a cyclohexyl benzene group, and a naphthyl group.

7. The liquid crystal display of claim 5, wherein
the vertical alignment side chain includes an alkyl group.

8. The liquid crystal display of claim 1, wherein
the vertical alignment side chain includes two or more vertical alignment side chains having different lengths.

9. The liquid crystal display of claim 8, wherein
the side chain with the shorter length among the vertical alignment side chains has a chain length with a carbon number of 4 to 6.

10. The liquid crystal display of claim 9, wherein
the side chain with the longer length among the vertical alignment side chains has a chain length with a carbon number of 9 to 11.

11. The liquid crystal display of claim 1, wherein
the vertical alignment side chains have the same length, and the chain length has a carbon number of 4 to 6.

12. The liquid crystal display of claim 1, wherein
the vertical alignment side chains have the same length, and the chain length has a carbon number of 9 to 11.

13. The liquid crystal display of claim 1, wherein
the main reaction monomer and the sub-reaction monomer include at least one acryl group or methacryl group at an end.

14. The liquid crystal display of claim 1, wherein
the main reaction monomer includes a benzene ring or a cyclohexyl group.

15. The liquid crystal display of claim 14, wherein
the benzene ring or the cyclohexyl group of the main reaction monomer is connected to the main chain by a chain with a carbon number of 8 to 20.

16. The liquid crystal display of claim 15, wherein
the benzene ring or the cyclohexyl group of the main reaction monomer is connected to the main chain by a chain with a carbon number of 10 to 18.

17. The liquid crystal display of claim 13, wherein
the sub-reaction monomer does not include the benzene ring or the cyclohexyl group.

18. The liquid crystal display of claim 17, wherein
the sub-reaction monomer has a chain length with a carbon number of 4 to 10.

19. The liquid crystal display of claim 12, wherein
a chain length difference between the main reaction monomer and the sub-reaction monomer has a carbon number of 5 to 10.

20. The liquid crystal display of claim 19, wherein
the chain length difference between the main reaction monomer and the sub-reaction monomer has a carbon number of 5 to 6.
